(19) United States
(12) Patent Application Publication
(10) Pub. No.: US 2016/0338511 A1
(43) Pub. Date: Nov. 24, 2016

(54) MOUNTING TOOL

(71) Applicant: HammerSafe, LLC, Iowa City, IA (US)

(72) Inventor: Timothy Jay Turner, Chicago, IL (US)

(21) Appl. No.: 15/160,173

(22) Filed: May 20, 2016

Related U.S. Application Data
(60) Provisional application No. 62/164,202, filed on May 20, 2015.

(51) Int. Cl. A47G 1/16; A47G 1/17; B25C 3/00

(52) U.S. Cl. CPC A47G 1/16; B25C 3/008; A47G 1/17

(57) ABSTRACT

An apparatus and method for mounting artwork to a wall. The apparatus includes a mounting tool adapted to facilitate measuring, positioning, aligning, and installing a piece of artwork. The method includes using the mounting tool to hang a piece of artwork on a mounting surface.

### CROSS-REFERENCE TO RELATED APPLICATIONS

This application claims priority to U.S. Provisional Application No. 62/164,202, filed May 20, 2015, the entirety of which is incorporated herein by reference.

### BACKGROUND OF THE INVENTION

Artwork and other decorative pieces are typically hung on a vertical mounting surface, such as a wall, for display. The typical way to display artwork or decorative pieces requires planning as well as multiple different tools, which can increase required time and costs. For example, a wire-hung painting requires a hanger to guess where the wire will extend, which creates room for error when hanging the painting.

Furthermore, in order to accurately mount the painting, tools such as a measuring tape, level, pencil, stud finder, hammer or mallet, and nails or hooks are required. Even with all of these tools, the picture may still end up being hung in the wrong position. Furthermore, an inexperience pictured hanger can damage the wall or other mounting surface if inexperienced in using a hammer or mallet. Such inexperience can leave the nails inserted at too great or too small of an angle, which can lead to poor installation or even falling of the artwork.

### BRIEF DESCRIPTION OF THE INVENTION

In one aspect, embodiments of the invention relate to a tool for mounting an artwork to a wall. The tool includes a body having a straightedge on a lower portion thereof and an arcuate edge on an upper portion thereof. The tool further includes a plurality of openings defined in the body between the upper portion and the lower portion, each of the openings having a lower edge generally aligned with the lower portion of the body. Further yet, the tool includes at least one fastener-receiving opening located in each of the plurality of openings with the at least one fastener-receiving opening configured to receive a plurality of types of fasteners.

In yet another aspect, embodiments relate to a method for mounting a piece of artwork having a hanging wire mounted to a rear surface thereof, onto a wall with a mounting tool including a body having an arcuate upper portion thereof, at least one opening, and at least one fastener-receiving opening defined in the body. The method includes: (1) placing the arcuate upper portion of the mounting tool along the hanging wire of the artwork; (2) tensioning the hanging wire by pushing the arcuate upper portion of the mounting tool toward an upper edge of the artwork; (3) measuring an offset distance between the upper edge of the artwork and the upper edge of the mounting tool after the tensioning step; (4) removing the mounting tool from placement with the hanging wire of the artwork; (5) positioning the mounting tool on the wall at the offset distance lower than a desired upper location of the artwork; and (6) passing the at least one fastener through the at least one fastener-receiving opening in the body of the mounting tool.

### BRIEF DESCRIPTION OF THE DRAWINGS

In the drawings:

FIG. 1 is a front view of a mounting tool.

FIG. 2 is a front view of the mounting tool of FIG. 1 illustrating alignment markers aligned with fastener-receiving openings.

FIG. 3 is an enlarged view of one fastener-receiving opening of FIG. 4 illustrating separate insertion sizes.

FIG. 4 is a rear view of the mounting tool of FIG. 1.

FIG. 5 is a cross-sectional view of the mounting tool of FIG. 1 illustrating an angled geometry for the fastener-receiving openings.

FIGS. 6-13 are front views of the mounting tool of FIG. 1 illustrating the different fastener mounting capabilities of the mounting tool.

FIG. 14 is a miniature version of the mounting tool of FIG. 1 according to another embodiment of the invention.

FIG. 15 is an enlarged version of the mounting tool of FIG. 1 according to yet another embodiment of the invention.

FIG. 16 is a flow chart illustrating a method of mounting a piece of artwork using the mounting tool of FIG. 1.

FIG. 17 is a perspective view of a measuring and marking step of the flow chart of FIG. 15.

FIG. 18 is a front view of the marking step of the flow chart of FIG. 15.

FIG. 19 is a front view of the measuring step of the flow chart of FIG. 16.

FIG. 20 is a front view of positioning the fastener in the center of the aperture of the mounting step of the flow chart of FIG. 15.

### DESCRIPTION OF EMBODIMENTS OF THE INVENTION

The described embodiments of the present invention are directed to a tool for mounting a piece of artwork to a wall. For purposes of illustration, the present invention will be described with respect to painting being hung on a wall. It will be understood, however, that the invention is not so limited and may have general applicability with differing art pieces, including pictures, canvas, framed artwork, sculpture, engraving, digital artwork on a hung medium, or any other form of art, which can be displayed on a wall.

It will be further understood that the term “mounting surface” or “wall” is exemplary of a vertical or substantially vertical mounting surface, and can be a wall of a structure, such as a home or a studio, a column or beam, or an easel, in non-limiting examples. Any such mounting surface or wall can be a surface upon which artwork is desirably mounted.

It will be further understood that the term “artwork” or “art” as used herein is intended to include any object that is desirable to hang or display on the mounting surface or wall. Non-limiting examples of artwork can include frame images, pictures, paintings, posters, sculptures, display case, collages, shelf, prints, canvas, engraving, digital artwork on mounted medium, wire-hung objects, or any other displayable art.

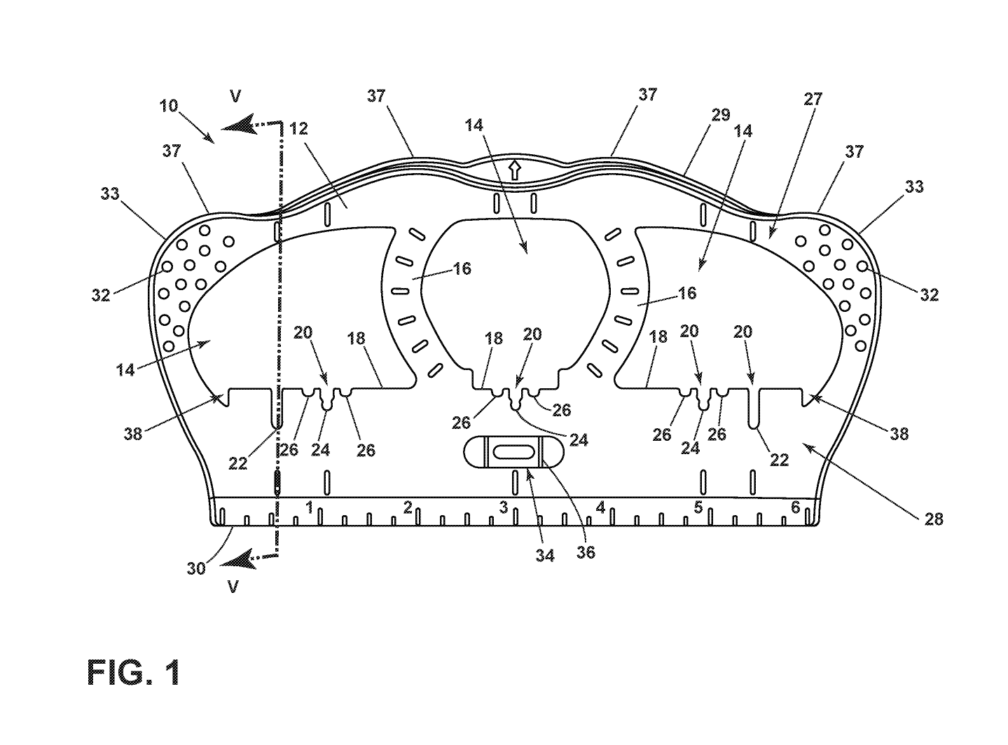

FIG. 1 illustrates a front view of a mounting tool 10. The mounting tool includes a body 12. The body 12 can be made of a robust material. Such a robust material can be strong enough to receive repeated pounding forces, such as hammer or mallet strikes, while being soft enough to dampen such blows without transferring a force to the structure or wall upon which the body 12 may rest. One example of such a material can include, but is not limited to, ethylene vinyl acetate (EVA) with polyethylene (PE). Such a robust material can also be somewhat flexible, capable or dampening vibratory forces from repeated strikes. The robust material should give a user confidence to strike the mounting tool 10, without fear of damaging the surface upon which the mounting tool 10 rests.

Three openings 14 are disposed in the body 12, defining two arcuate arms 16 between adjacent openings 14. The arms 16 are arcuate, including bowed portion curving away from the center horizontal center of the body 12. It should be understood that the number of openings 14 is non-limiting and can include one or more openings 14, which can define one or more arms 16. Linear lower edges 18 can be defined in the body 12 at the bottom of the openings 14. The lower edge 18 can be disposed at an angle in the direction moving from the front to the back of the mounting tool 10. For example, the lower edge 18 be disposed at about a 30 degree angle, as is common in the industry for the insertion of mounting fasteners, while other angles are contemplated that may depend on the particular fastener.

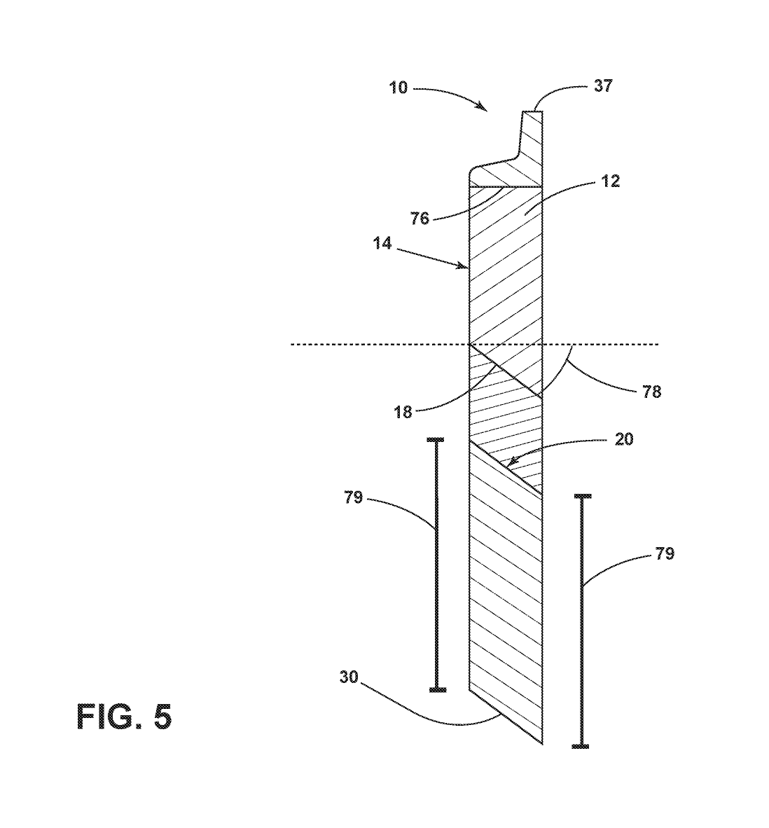

Fastener-receiving openings 20 can be defined within the openings 14 along the lower edges 18, being disposed in the body 12. There can be multiple types of fastener-receiving openings 20, adapted to receive different types of fasteners (see FIGS. 5-12). The fastener-receiving openings 20 can include a first fastener-receiving opening 24, a second fastener-receiving openings 26, or a third fastener-receiving openings 22. The first fastener-receiving opening 24 can be a two-part opening, adapted to receive single-shafted fasteners having differing diameters. The second fastener-receiving openings 26 can be a pair of openings in spaced lateral relationship to the first opening. For example, the pair of second fastener-receiving openings 26 can be spaced on both sides of the first fastener-receiving opening 24. The second fastener-receiving opening 26 can be used to mount a double-shafted fastener, such as a double nail hook, in one non-limiting example. The third fastener-receiving opening 22 can be an elongated fastener-receiving opening 20 for receiving fasteners capable of supporting a lesser weight as opposed to the other fastener-receiving openings 20, such as a 20 lb mounting hook in one non-limiting example. The third fastener-receiving opening 22 can be located on one lateral side of the second opening. It should be understood that the fastener-receiving openings 20 as illustrated is exemplary. The fastener-receiving openings 20 can be formed in any order or arrangement along the lower edges 18. Any number of fastener-receiving openings 20 can be included, and the fastener-receiving openings 20 should not be limited as shown.

It should be understood that the fastener-receiving openings 20 are angled downwardly, from front to back. The angle of the fastener-receiving openings 20 can be twenty degrees in one non-limiting example, facilitating particular manufacturer recommend insertion of a fastener through the fastener-receiving openings 20. Additionally, it should be understood that the fastener-receiving openings 20 are adapted to hold a fastener during insertion into a wall, providing for hands-free insertion of the fastener.

An upper portion 27 and a lower portion 28 can define the extent of the body 12. The upper portion 27 can include an arcuate edge 29 terminating at a straightedge 30 disposed along the lower portion 28 of the mounting tool 10. The arcuate edge 29 can include discrete curvatures, such as concave and convex portions. Additionally, inflection points between the concave and convex portions can define the arcuate edge 29. The arcuate edge 29 can include a recess at a central portion. The openings 14 are defined in the body 12 between the upper portion 27 and the lower portion 28. The lower edge 18 can be generally aligned with the straightedge 30, such as being parallel to the straightedge 30 in one example.

The straightedge 30 can be defined in the body 12 at the lower portion 28 of the mounting tool 10. The straightedge 30 can be a ruler in one example, and is linear, disposed parallel to the lower edges 18 of the openings 14. The straightedge ruler 30 as illustrated is about six inches, but can be any length defined by the size of the body 12.

A plurality of hand grip portions 32 can be disposed on the body 12. The grip portions 32 can be made of the same material as the body 12, and can be formed integral with the body 12. The grip portions 32 as illustrated are located on opposing side portions 33 of the upper portion 27.

A level aperture 34 can be disposed in the body 12 between the openings 14 and the straightedge 30. The position of the level aperture 34 is exemplary and can be place anywhere within the body 12. A level 36, such as a bubble level, can be placed within the level aperture 34. The level 36 can be disposed parallel to the straightedge 30, such that placing the linear straightedge 30 along a surface enables a user to use the level 36 to determine the planar level of the surface.

Four touch points 37 are defined along the arcuate edge 29. The touch points 37 are defined by convex curves of the arcuate edge 29, between adjacent concave curves. The touch points provide for contacting a wire during artwork hanging to simulate the tensioned, mounted position of the wire.

Two recesses 38 are disposed in the outer openings 14. The recesses 38 can be used for supporting fasteners when not in use or for positioning additional fasteners outside of the defined fastener-receiving openings 20.

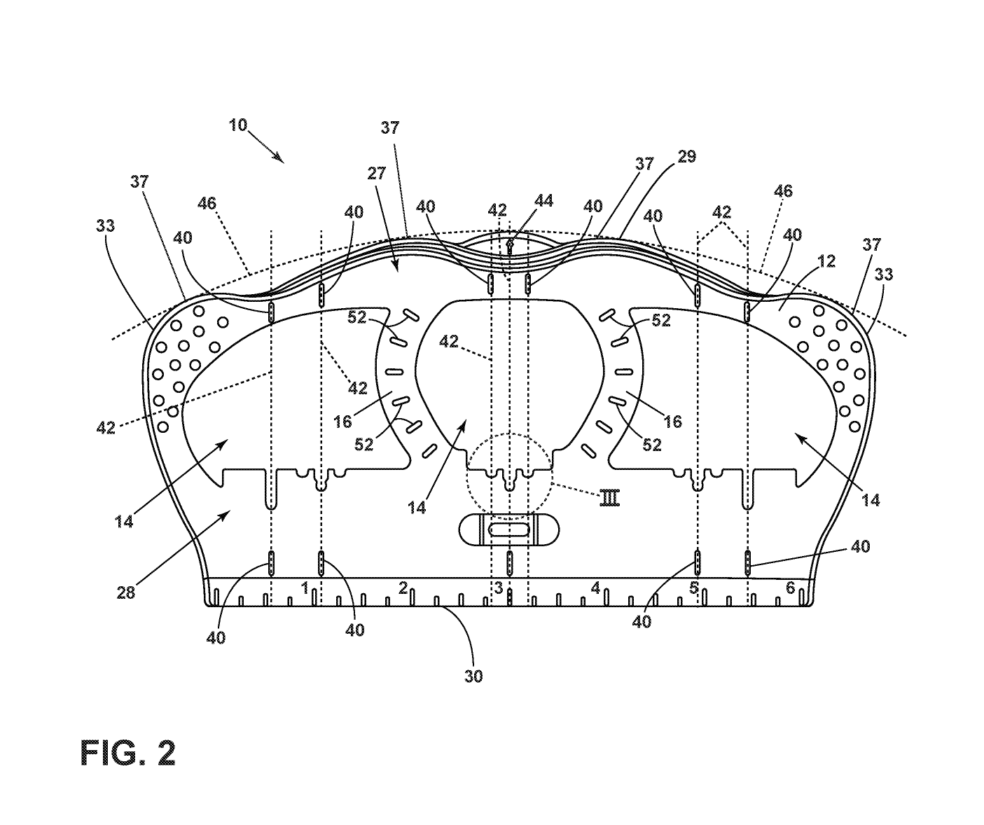

Referring now to FIG. 2, one or more markers 40 can be disposed on the body 12. The markers 40 can be colored representations, or can be contoured portions of the body 12, such as raised elements or recessed portions. The markers 40 can align with the fastener-receiving openings 20, illustrated by the vertical lines 42. As such, the user can use the fastener-receiving openings 20 to mark a piece of artwork or a surface at the top of the mounting tool 10 using the markers 40. One of the markers 40 can be an arrow, aligned at the horizontal center of the mounting tool 10.

An arc 46 can be defined by the arcuate edge 29 at the top of the mounting tool 10. The arcuate edge 29 can be adapted to for the arc 46 particular to a taut, arcuate wire for mounting a piece of artwork, for example. In one particular example, the arcuate edge 29 includes the four touch points 37 for contacting such a wire. The touch points 37 provide for determining an equal tension on any wire when placing the mounting tool 10 against a wire. As the tension and length of wires among artwork can vary, the arcuate edge 29 having the touch points 37 can provide for an even, symmetric position on any wire. In the instance that the inner-most touch points 37 contact the wire, the outer-most touch points can provide as a visual indicator to the user that even pressure is being applied to the wire, providing symmetrical positioning of the mounting tool 10.

The body 12 can further include center markers 52 disposed on the arms 16 around the center opening 14. The center marker 52, for example, can be raised portions of the body 12, or can be hardened members, for receiving multiple blows, while minimizing such contact with the body surface 12. Additionally, the markers 52 can be used to align the center of the middle opening 14.

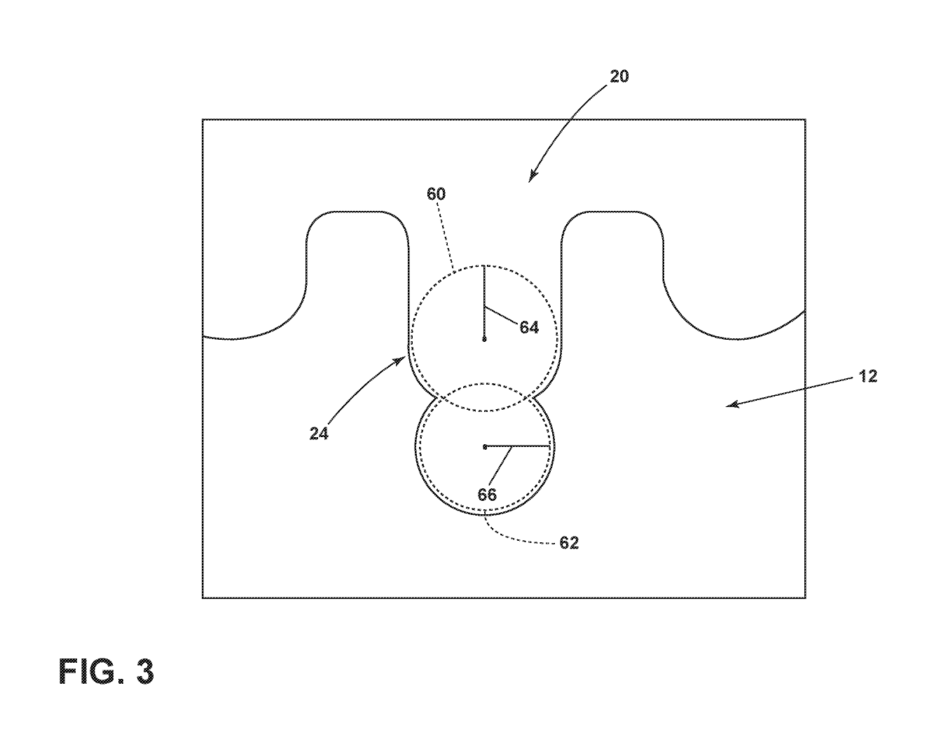

Referring to FIG. 3, the enlarged section-III of FIG. 2 is illustrated, showing the first fastener-receiving opening 24. A wide-necked portion 60 and a narrow-necked portion 62 are defined within the first fastener-receiving opening 24, with the wide-necked portion 60 defining a larger radius 64 than the narrow-necked portion 62, having a smaller radius 66. The wide and narrow-necked portions 60, 62 can overlap one another. The first fastener-receiving opening 24 is adapted to have the wide and narrow-necked portions 60, 62 to support for the insertion of different types of fasteners, having different radiuses. Such fasteners can include nails or hooks designed to support different weights of objects. In one particular example, the wide-necked portion 60 includes a larger radius, to support a larger radiused fastener, such as 50 lb hook. Alternatively, the narrow-necked portion 62 includes a smaller radius for supporting a thinner fastener, such as a 30 lb or 20 lb hook.

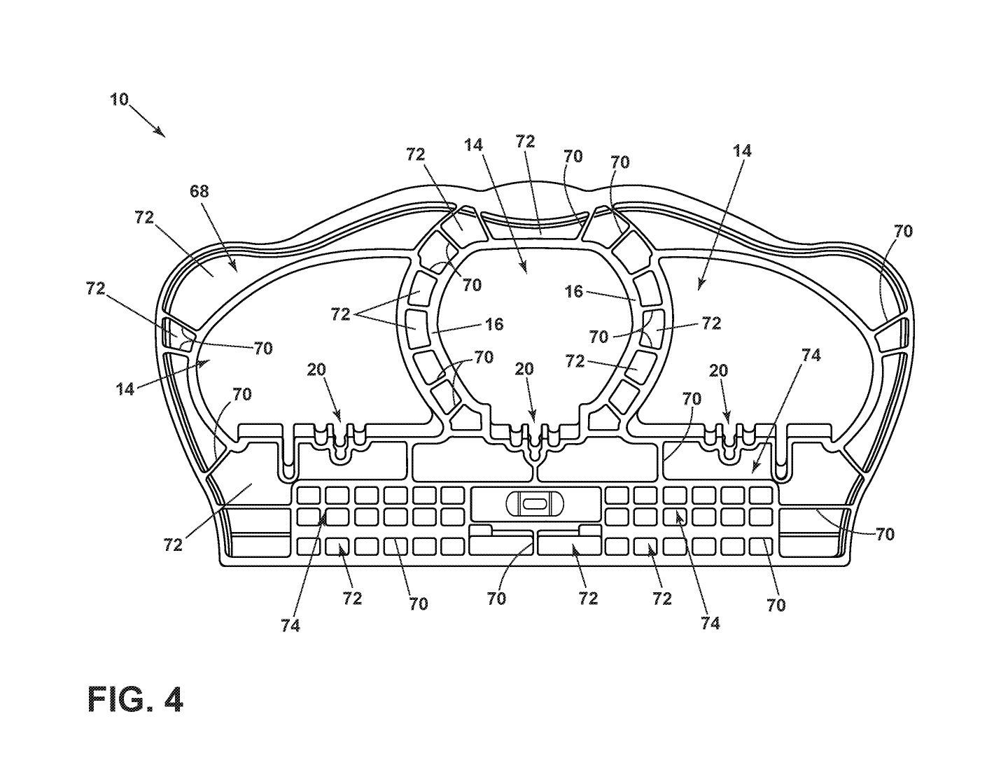

Referring now to FIG. 4, a rear 68 of the mounting tool 10 illustrates a system of ribs 70 and cavities 72 defined by the ribs 70. The ribs 70 provide for structural support of the mounting tool 10, while the cavities 72 provide for reduced weight and cost. The ribs 70 can form two grid areas 74 between the openings 14 and the lower portion 28 of the mounting tool 10. The grid areas 74 are a group of closely organized ribs 70 providing a gapped surface for supporting a removable adhesive. The grid areas 74 protrude from the rear 68 of the mounting tool 10 by one-thirty-second of an inch, facilitating placement of the removable adhesives. Additionally, the protrusion of the grid areas 74 provide for adjusting the tool 10 based upon any curves or indents in the wall, which can otherwise position the mounting tool 10 unevenly. The grid areas 74 can provide for attaching adhesives such as putty, double sided tape, or other adhesives in non-limiting examples, facilitating attaching the mounting tool 10 to the mounting surface. Such attaching of the mounting tool 10 provides for hands-free operation of the mounting tool 10.

It should be appreciated that the organization of the ribs 70 and the cavities 72 defined by the ribs 70 is exemplary. One skilled in the art should understand that the ribs 70 provide for structural support of the mounting tool 10 and that the addition of more ribs 70 can increase the structural integrity of the mounting tool 10 or removing ribs 70 creating more or larger cavities 72 can decrease structural integrity while reducing weight or material cost. Any reorganization of geometry of the ribs 70 and the cavities 72 as illustrated is contemplated without departing from the scope of the invention.

A plurality of ribs 70 are also disposed within the arms 16. The ribs 70 within the arms 16 provides for increased structural support for the arms 16, enabling the body 12 to receive multiple forceful strikes, such as from a hammer or mallet, along the center of the mounting tool 10.

Additionally, ribs 70 can be strategically placed along the body 12 to provide increased support where support may be needed. Such areas of additional support can include, for example, areas where repeated hammer or mallet strikes are anticipated or near the fastener-receiving openings 20 to prevent deformation under prolonged use.

Referring now to FIG. 5, a cross-sectional view of the mounting tool 10 illustrates an angled geometry for portions of the mounting tool 10. An upper opening surface 76 can be substantially parallel to the surface of the arcuate edge 29. Both the arcuate edge 29 and the upper opening surface 76 can be substantially orthogonal to the front and the back of the mounting tool 10.

As can be appreciated, the lower edge 18, the fastener-receiving opening 20, and the straightedge 30 are disposed at an angle 78. The angle 78, for example, can be between fifteen degrees and forty-five degrees, and can between twenty-eight degrees and thirty-two degrees in non-limiting examples. In another non-limiting example, the angle can be thirty-degrees. The angle 78 is disposed at the manufacturer proscribed preferred angle for inserting a fastener into a wall. Thus, the angle 78 for the fastener-receiving openings 20 can be adapted to insert the fastener at the proper insertion angle for each type of fastener. For example, the second fastener-receiving opening 26 having two spaced fastener-receiving openings can be angled at thirty degrees, for mounting a 50 lb professional double hook fastener. As can be appreciated, the fastener-receiving openings 20 can be disposed at an angle 78 adapted to insert the fasteners at the proper angle 78.

Furthermore, a height 79, defined as the distance from the straightedge 30 to the bottom of the fastener-receiving opening 20, is particularly measured. The height 79 anticipates the hanging distance from a nail of an inserted fastener and the hook below the nail, in order to precisely hang the artwork from the wire at the hook, being positioned below the nail.

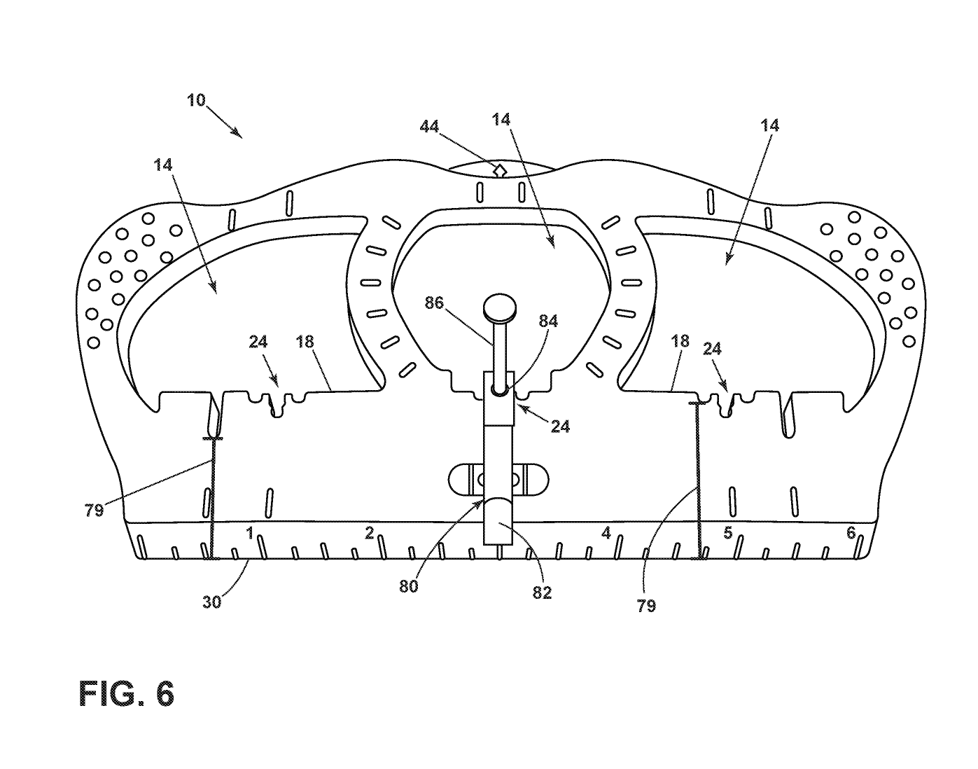

Referring now to FIGS. 6-13, multiple different fasteners are positioned within the fastener-receiving openings 20 of the mounting tool 10. The different fasteners as illustrated are exemplary of different organizations for mounting artwork having different weights or dimensions. FIG. 6 illustrates a single-shafted fastener as single 50 lb conventional hook fastener 80. A single-shafted fastener should be understood as a fastener having a single elements for insertion into the wall to mount the fastener. The fastener 80 includes a hook 82 and an aperture 84, having a nail 86 disposed in the aperture 84, as is typical with standard hook-type fasteners. The fastener 80 is rated for 50 lb, and the nail 86 has a radius adapted to be received in the wide-necked portion 60 of the first fastener-receiving opening 24 (see FIG. 3).

The mounting tool 10 is designed having the lower edges 18 of the openings 14 spaced from the straightedge 30 by a particular height 79. The height 79 is designed to be similar or equal to the length of the fastener 80. As such, mounting the fastener 80 with the nail 86 disposed in the fastener-receiving opening 20 will position the hook 82 at the straightedge 30. Thus, the height 79 is useful for accurately positioning the fastener 80 along a wall or structure. Additionally, the first fastener-receiving opening 24 is aligned with the center marker 44, for aligning the fastener 80 with the center of the mounting tool 10.

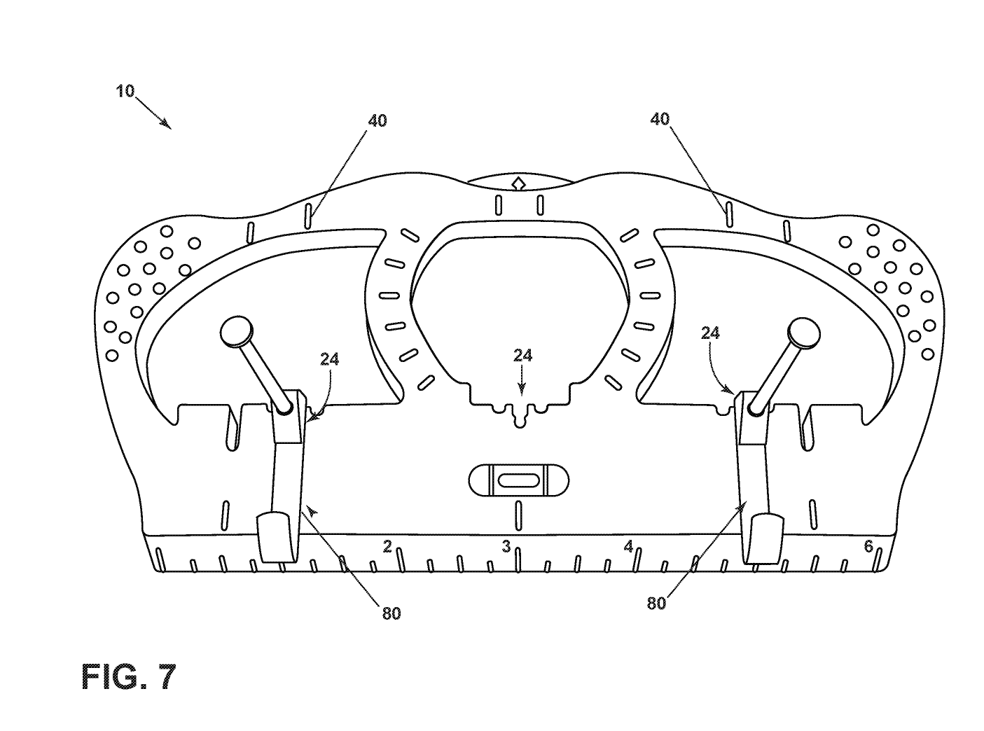

FIG. 7 is similar to that of FIG. 6, having two single-shafted fasteners as two single 50 lb conventional hook fasteners 80 disposed in the first fastener receiving openings 24 defined within the two outer openings 14. The mounting tool 10 can align both fasteners 80, while providing support for up to 100 lbs of artwork. The markers 40 associated with the outer first fastener receiving openings 24 can be used for aligning the mounting tool 10 and the fasteners 80 disposed within the first fastener receiving openings 24. It should be appreciated that the mounting tool 10 is capable of combining multiple fasteners 80 in mounting a piece of artwork.

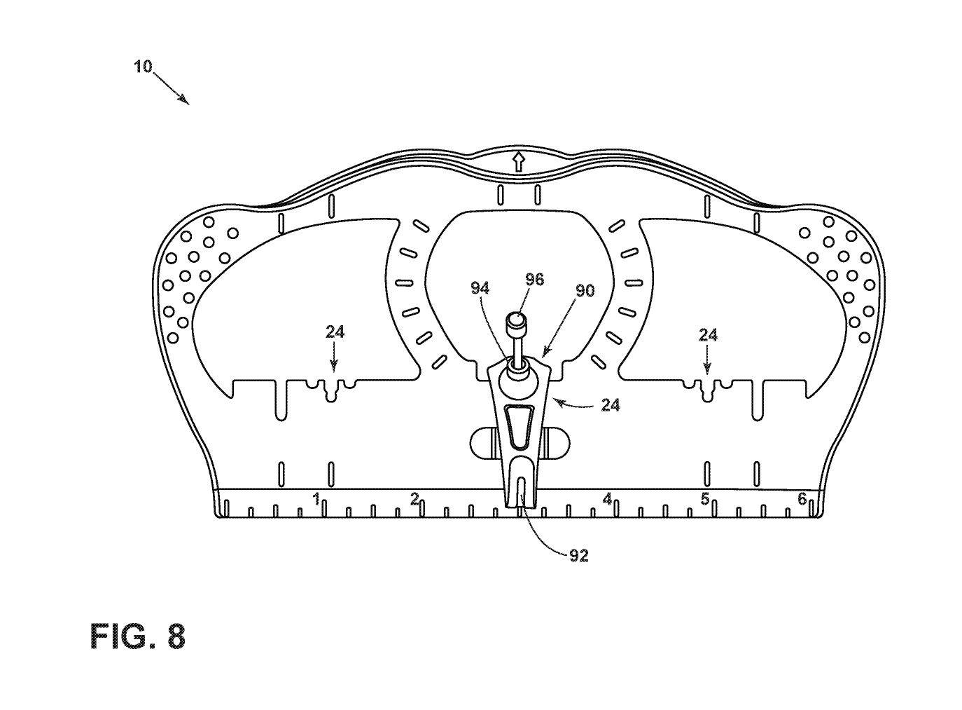

FIG. 8 illustrates another single-shafted fastener 90, as a 30 lb professional hook fastener 90. The fastener 90 includes a hook 92 and an aperture 94, with a nail 96 disposed in the aperture 94, similar to the fastener 80 of FIGS. 6-7. The nail 96, however, is thinner than the nail 86 of FIGS. 6-7, with the nail 96 being designed to support a lesser weight. As such, the nail 96 can be received within the narrow-necked portion 62 of the first fastener-receiving opening 24 (see FIG. 4). Thus, it should be appreciated that the first fastener-receiving opening 24 as described herein is capable of supporting different types of hooked-fasteners 80, 90, while properly aligning the hooks 82, 92.

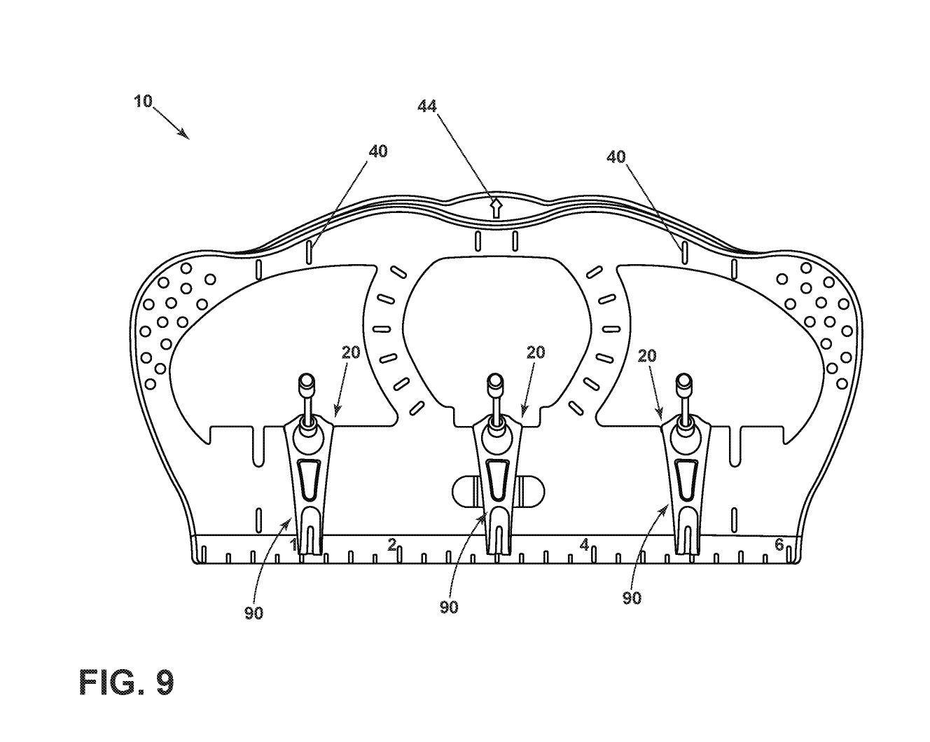

FIG. 9 illustrates three single-shafted fasteners as three 30 lb professional hook fasteners 90 disposed within fastener-receiving openings 20 in all three openings 14. The fasteners 90 can be disposed in the narrow-necked portion 62 of the first fastener-receiving openings 24, being aligned with the respective markers 40, 44. It should be appreciated that the mounting tool 10 can provide for installation using up to three fasteners 90, such as for supporting artwork having a greater weight.

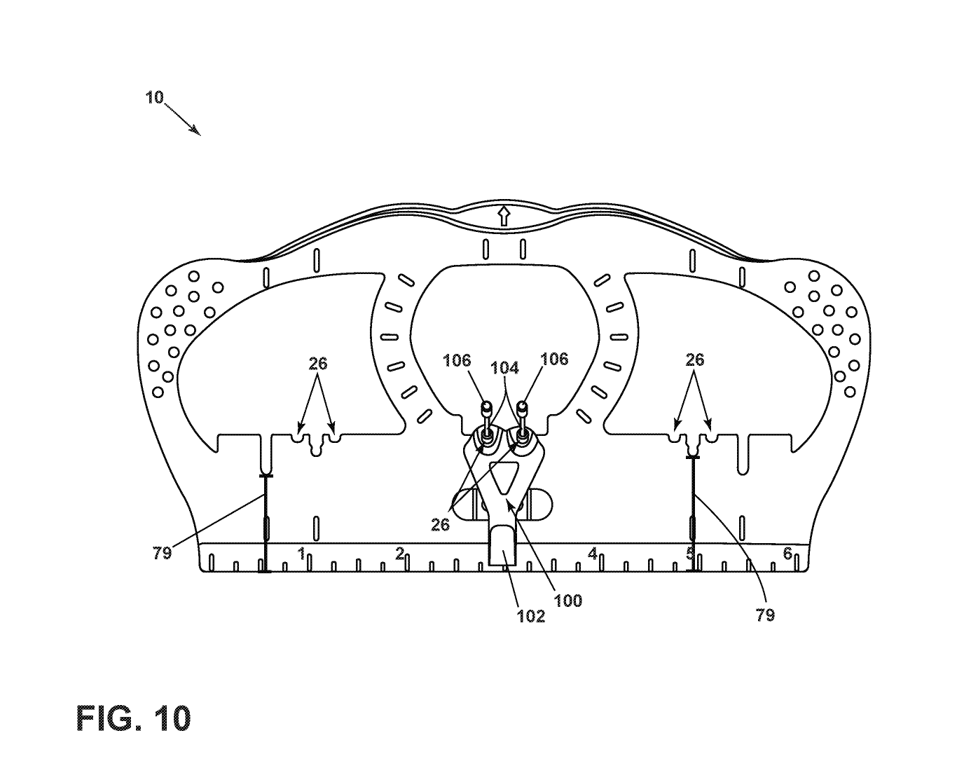

FIG. 10 illustrates a double-shafted fastener supported by the mounting tool 10 being a 50 lb professional double-nail hook fastener 100. A double-shafted fastener should be understood as a fastener having two extensions for insertion into the wall for mounting the fastener. The fastener 100 can include a hook 102, with two apertures 104 and two nails 106. The double-nail style fastener 100 is provided in the second fastener-receiving openings 26, with the second fastener-receiving openings 26 adapted to receive the separate nails 106 of the fastener 100. The second fastener-receiving openings 26 are adapted to align the fastener 100, while positioning the hook 102 at the lower portion 28 of the mounting tool 10 by the particular height 79 of the fastener-receiving openings 20.

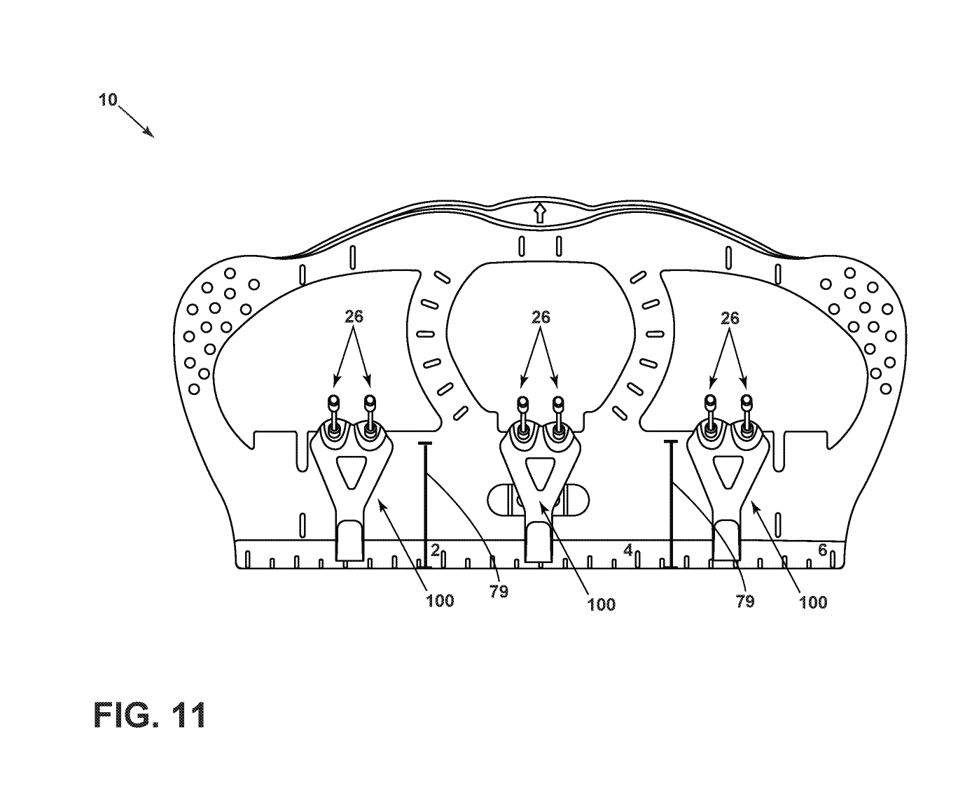

FIG. 11 illustrates three doubled shafted fasteners as three of the 50 lb professional double-nail hook fasteners 100 disposed in three sets of the second fastener-receiving openings 26 within the three separate openings 14. The mounting tool 10 can support and align three separate double-nail-type fasteners 100 for mounting a heavy piece of artwork.

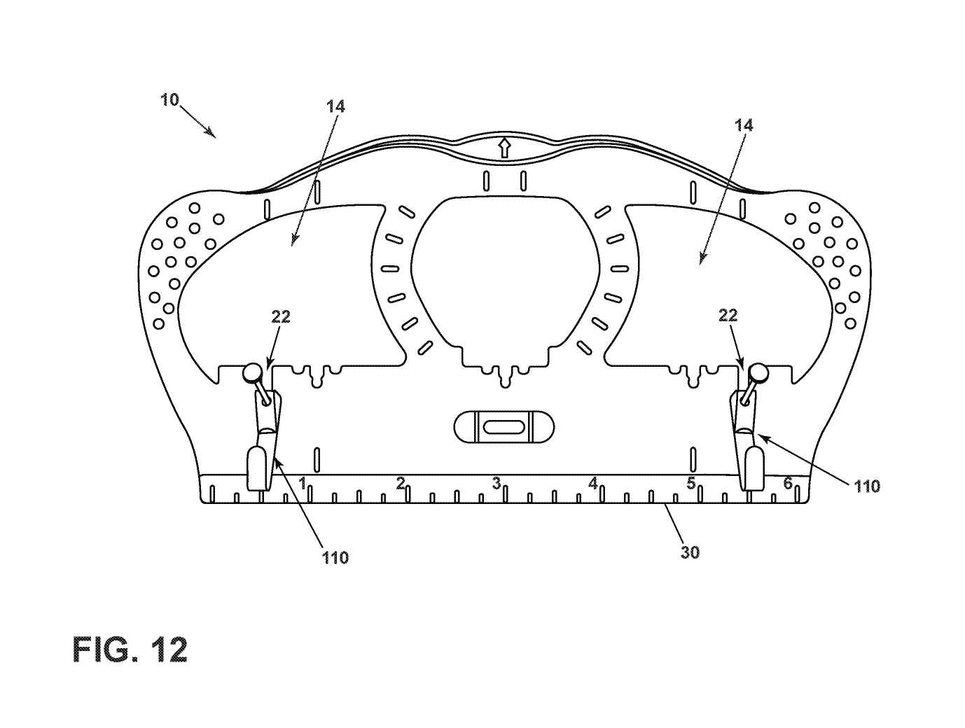

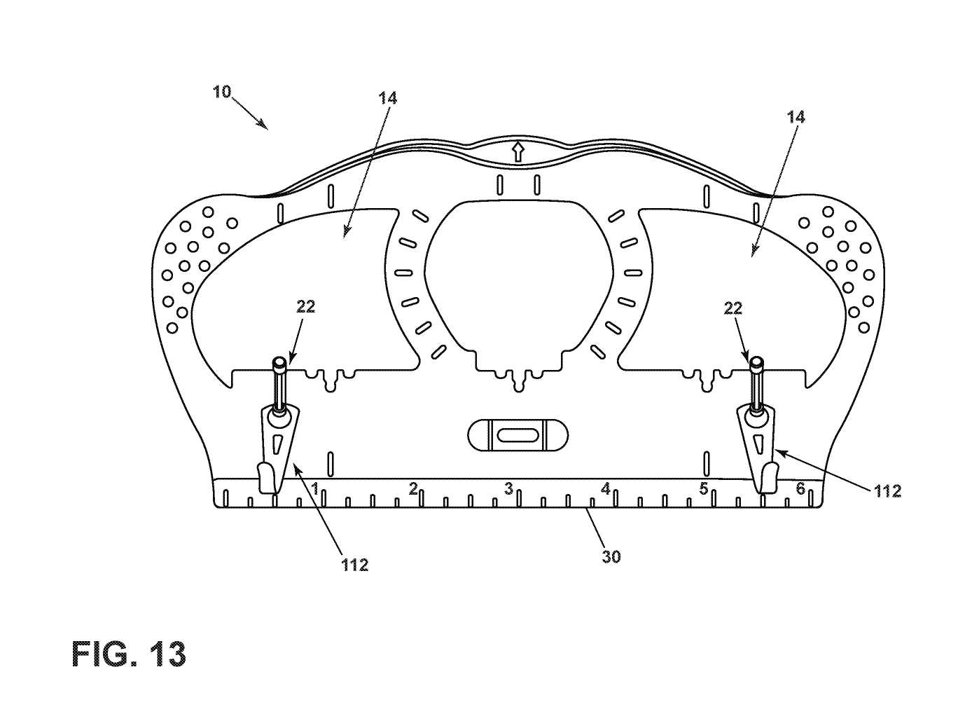

FIG. 12 illustrates two single-shafted fasteners as two 30 lb conventional hook fasteners 110 disposed in the third fastener-receiving openings 22 disposed in the outer openings 14. FIG. 13 illustrates two single-shafted fasteners as two 20 lb professional hook fasteners 112 disposed in the third fastener-receiving openings 22. It should be appreciated that the third fastener-receiving openings 22 are capable of supporting multiple different fasteners. For example, the third fastener-receiving openings 22 can be particularly used for fasteners having shortened hooks, such that the hooks are properly aligned with the lower portion 28 of the mounting tool 10 at the straightedge 30.

It should be understood that the plurality of fastener-receiving openings 20 as organized in the mounting tool 10 can support multiply different types of fasteners. Such fasteners can nails, screws or other threaded fasteners, clips, locks, anchors, hooks, tacks, bolts, pins, rivets, 20 lb hooks, 30 lb hooks, 50 lb hooks, single-nail hooks, double-nail hooks, single-shafted fasteners, double-shafted fasteners, or triple-shafted fasteners in non-limiting examples. In particular, the fastener-receiving openings 20 are oriented at a particular height 79 from the lower portion 28 of the mounting tool 10 at the straightedge 30 for particularly aligning hooks as described in FIGS. 6-13, such as for hanging a wire-hung artwork in one example.

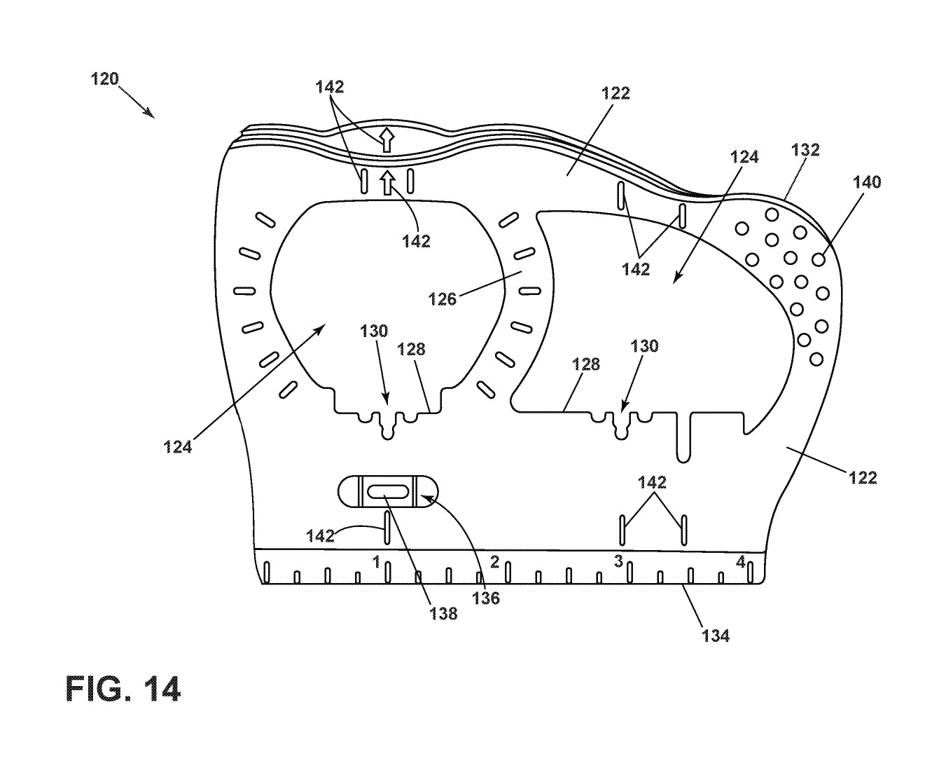

Referring now to FIG. 14, another exemplary embodiment of a miniature mounting tool 120 is illustrated having a smaller design. The mounting tool 120 includes a body 122 having two openings 124 with a wall 126 disposed between the openings 124. The openings 124 include a lower edges 128 having multiple fastener-receiving openings 130, adapted to receive one or more fasteners. The fastener-receiving openings 130 can include differing width, or heights, or can be two-part as illustrated in FIG. 3. Similarly, the fastener-receiving openings 130 can be adapted to receive the fasteners as illustrated in FIGS. 6-13.

The mounting tool 120 includes a rounded edge 132 terminating at a straightedge 134 disposed on the lower portion 28 of the mounting tool 120. The rounded edge 132 can be adapted to an anticipated arcuate disposition of a hanging wire for mounting a piece of artwork. The body 122 can further include a level aperture 136 for receiving a level 138. The body 12 can further include a plurality of grip portions 140 and markers 142. The grip portions 140 can facilitate gripping of the mounting tool 120 while the markers 142 can be aligned with the fastener-receiving openings 130 for aligning a fastener disposed in the fastener-receiving openings 130.

Similar to the mounting tool 10 of FIG. 4, the rear of the mounting tool 120 can include a plurality of ribs and cavities for supporting the mounting tool 120, providing structural integrity, or attaching removable fasteners, such as tape.

It should be appreciated that the mounting tools of FIG. 14 and of FIG. 1 can be substantially similar, with the mounting tool 120 of FIG. 14 being a smaller version for smaller artwork or compact usage.

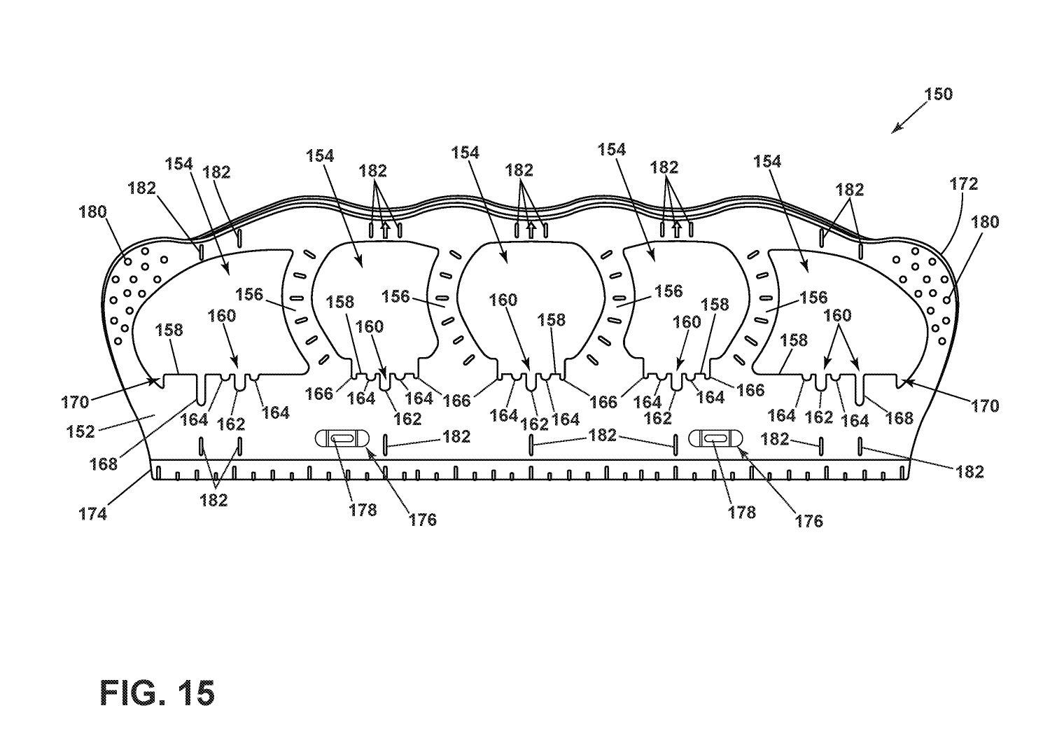

Turning to FIG. 15, yet another exemplary embodiment of a professional mounting tool 150 is illustrated having a larger, wider design. Such a design can be beneficial for professional or larger artwork uses. The mounting tool 150 includes a body 152 having five openings 154 with four walls 156 disposed between the openings 154. The openings 154 include a lower edge 158 having multiple fastener-receiving openings 160 in each lower edge 158. The fastener-receiving openings 160 are adapted to receive one or more fasteners for mounting a piece of artwork. The fastener-receiving openings 160 can include differing widths, heights, or can be two-part as illustrated in FIG. 3. The three openings 154 in the center of the mounting tool 150 include lower edges 158 with a first fastener-receiving openings 162 which can be the two-part fastener-receiving opening illustrated in FIG. 3, and spaced, second fastener-receiving openings 164 as well as two spaced, heavy fastener-receiving openings 166. The outer two openings 154 include the first fastener-receiving openings 162, the second fastener-receiving openings 164, as well as a third fastener-receiving opening 168, which can be the elongated fastener-receiving opening. The outer openings 154 also include a recess 170. The first fastener-receiving openings 162, the second fastener-receiving openings 164, and the third fastener-receiving openings 168 can function similar to the fastener-receiving openings 20 as described in reference to FIGS. 1-13. The spaced heavy fastener-receiving openings 166 can be used to support a fastener adapted to carry a larger weight, such as 100 lbs or greater. Additionally, the lower edges 158 can be used to support additional fasteners within the outer openings 154.

The mounting tool 150 includes a rounded edge 172 terminating at a straightedge 174 disposed on the lower portion of the mounting tool 150. The rounded edge 132 can be adapted to an anticipated arcuate disposition of a hanging wire for mounting a piece of artwork. The body 152 can include two or more level apertures 176 for receiving a level 178 in each level aperture 176. The body 152 can include a plurality of grip portions 180 and markers 182. The grip portions 180 can facilitate gripping of the mounting tool 150 while the markers 182 can be aligned with the fastener-receiving openings 160 for aligning fasteners disposed in the fastener-receiving openings 160.

Similar to that of the mounting tool 10 of FIG. 4, the rear of the mounting tool 150 can include a plurality of ribs and cavities for supporting the mounting tool 150, providing structural integrity, or attaching removable fasteners such as tape.

It should be appreciated that the mounting tool 150 as illustrated and described for FIG. 15 can be substantially similar to the mounting tools 10, 120 of FIGS. 1 and 14. The mounting tool 150 of FIG. 15 is an elongated, larger version which may be necessary for mounting larger artwork

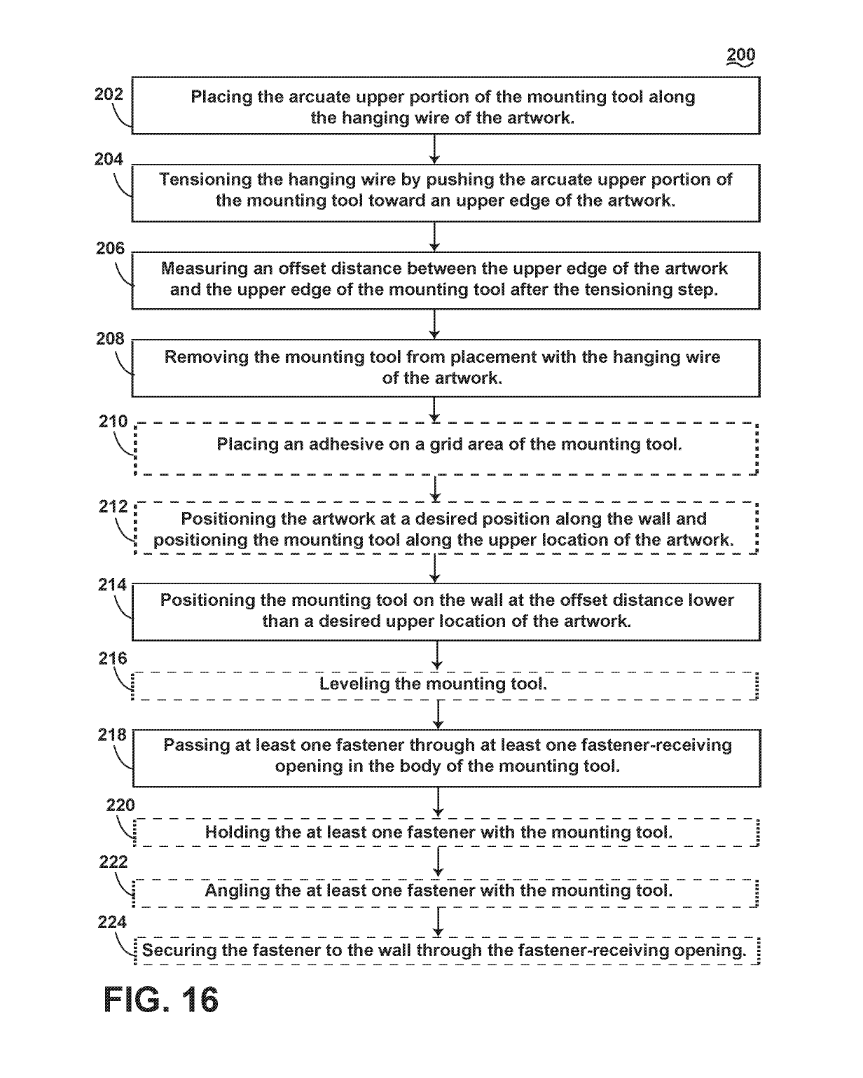

FIG. 16 is a flow chart illustrating a method 200 of mounting a piece of artwork with a mounting tool, such as the mounting tools 10, 120, 150 of FIGS. 1, 14, and 15. The method 200 can include at least six steps for mounting a piece of artwork having a hanging wire mounted to a rear surface thereof, onto a wall with a mounting tool including a body having an arcuate upper portion thereof, at least one opening, and at least one fastener-receiving opening defined in the body, including method steps: (1) at 202, includes placing the arcuate upper portion of the mounting tool along the hanging wire of the artwork; (2) at 204, includes tensioning the hanging wire by pushing the arcuate upper portion of the mounting tool toward an upper edge of the artwork; (3) at 206, includes measuring an offset distance between; (4) at 208, includes removing the mounting tool from placement with the hanging wire of the artwork; (5) at 214, includes positioning the mounting tool on the wall at the offset distance lower than a desired upper location of the artwork; and (6) at 218, includes passing at least one fastener through the at least one fastener-receiving opening in the body of the mounting tool.

Optionally, the method 200 can include additional steps, illustrated in dashed-line boxes. It should be understood that the method can include one or more of the optional steps, or none of the additional steps. As such, the method 200 can further include, at 210 prior to the positioning step 216, placing an adhesive on a grid area of the mounting tool prior to placing the mounting tool along the upper location of the artwork. The method 200 can also optionally include, at 212, prior to the positioning step 216, positioning the artwork at a desired position along the wall and positioning the mounting tool along the upper location of the artwork. At 216, prior to the passing step 218, the method 200 can also include leveling the mounting tool. The method 200 can also optionally include, after the passing step 218, at 220, holding the at least one fastener with the mounting tool, at 222, angling the at least one fastener with the mounting tool, or, at 224, securing the fastener to the wall through the fastener-receiving opening.

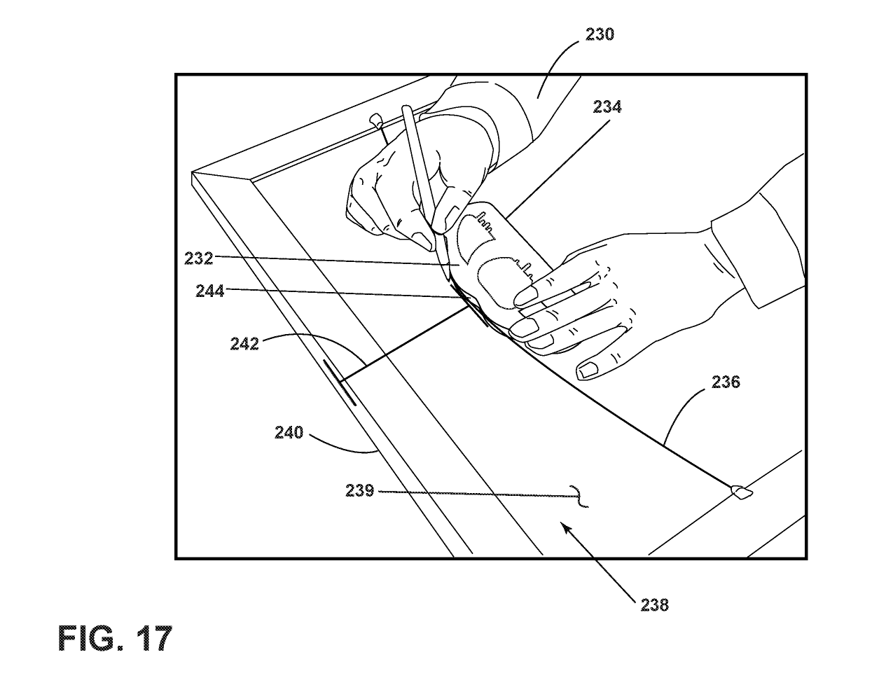

Turning now to FIG. 17, steps (1)-(3) at 202, 204, and 206 of FIG. 16 can be appreciated. Prior to the first step, at 202, a user can find the horizontal center of the artwork. This can be done with the mounting tool or with a ruler having a length sufficient to find the center of the artwork. Finding the center of the artwork provides for centered mounting of the artwork. A user 230 can place an upper portion 232 of a mounting tool 234 along an arcuate hanging wire 236 of an artwork 238 having a rear surface 239. The user 230 pushes the mounting tool 234 toward an upper edge 240 of the artwork 238 in order to tension the hanging wire 236. Pushing the mounting tool 234 upward pushes the touch points of the arcuate edge of the tool against the wire 236, simulating tensioned hanging of the artwork. Some wires will only touch the middle touch points. The outer touch points can be balanced by the user to insure even tensioning by positioning the outer touch points at equal distances from the tensioned wire. This simulated tensioned hanging position can be used to accurately predict the position of the wire during hanging. The user can then mark the position of the wire at the horizontal center of the artwork for a single fastener, or can mark outer positions for multiple fasteners.

The user 230 can measure an offset distance 242 between the upper edge 240 and an arcuate edge 244 of the mounting tool 234. The user 230 can mark the artwork 238 to ensure the offset distance 242 is measured from the horizontal center of the artwork 238, and record any marks adjacent to any markers for using multiple fasteners. It should be appreciated that the position of the arcuate edge 244 that is marked will be different for one fastener or for multiple fasteners, as the arcuate edge 244 is lower as it moves from the center of the mounting tool 234. As such, the mounting tool 234 can anticipate the higher or lower position of the wire based upon the number of hooks. Thus, the mounting tool 234 contemplates the slight different in position of a one-hook, or multiple-hook implementation. The offset distance 242 can be used to anticipate the position of the artwork 238 on a wall where hung from a fastener, ensuring accurate positioning of the fastener to provide accurate positioning of the artwork 238 on the wall.

After the measuring step 206, the tool can be removed from placement with the hanging wire 236 on the artwork 238 at step 208.

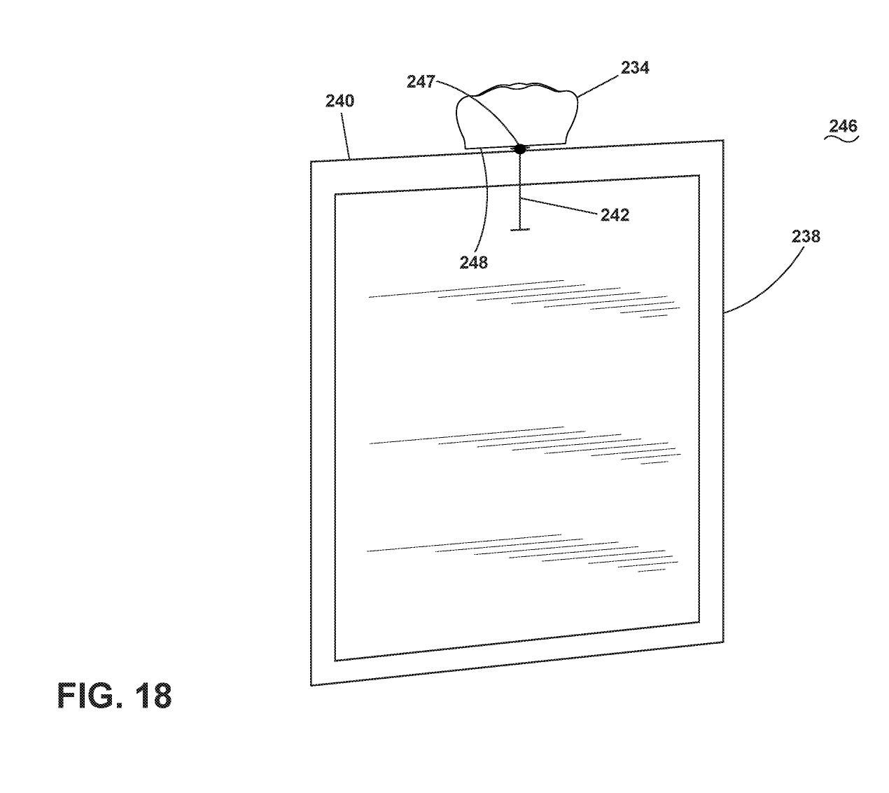

Referring now to FIG. 18, prior to step 214, the mounting tool 234 can be positioned on a wall 246, or other similar mounting surface. The mounting tool 234 can be positioned by first positioning the artwork 238 against the wall 246 at the desired mounting position. The mounting tool 234 is positioned along the upper edge 240 of the artwork 238 and the artwork can be removed. Prior to positioning the mounting tool 234 on the wall along the upper edge 240 of the artwork 238, an adhesive can be placed on the rear of the mounting tool 234 on the grid area. This can facilitate adhesion of the mounting tool 234 to the wall 246, providing for hands-free usage of the mounting tool 234. Alternatively, the position of the upper edge 240 can be marked on the wall 246 and the mounting tool 234 can be placed at the mark 247. Thus, it should be appreciated that the mounting tool 234 can be used to mark the position of the artwork 238, as well as conventional methods such as marking the wall 246. The artwork 238 can be removed and the offset distance 242 can be measured from a straightedge 248 downward of the mounting tool 234.

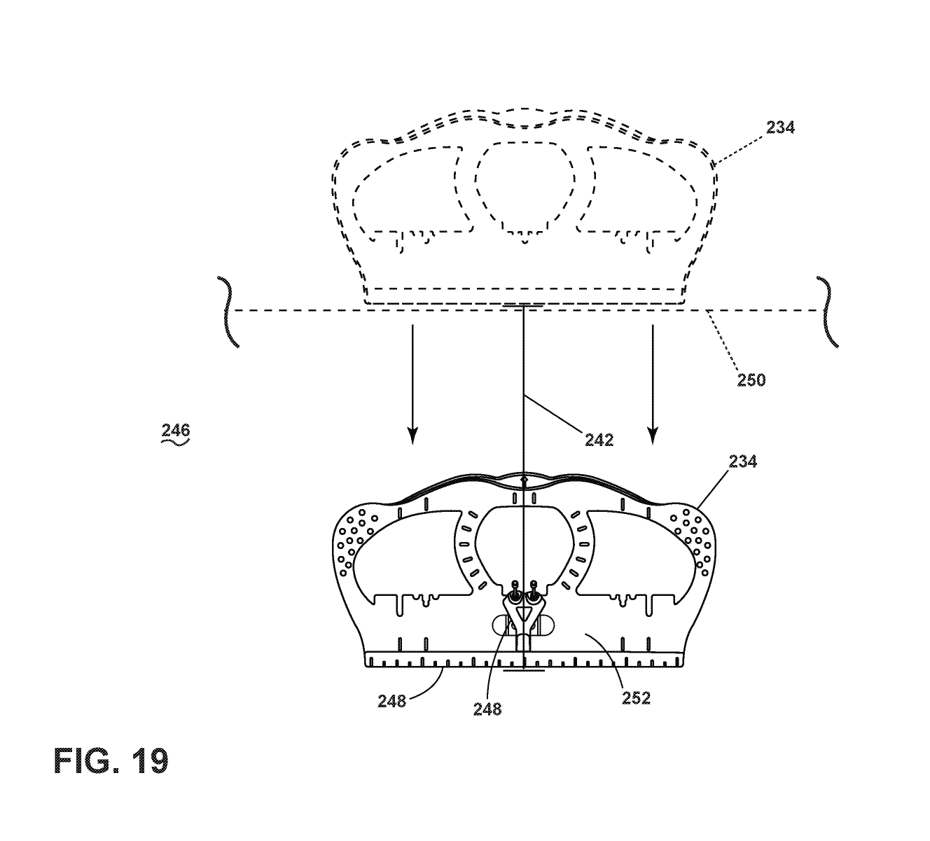

Turning now to FIG. 19, step 218 can be appreciated. The mounting tool 234 can be positioned on the wall at the offset distance 242 lower than the desired upper location 250 of the artwork 238. Positioning the mounting tool 234 at the offset distance 242 precisely positions the mounting tool 234 for inserting a fastener to hang the artwork 238 at the initial position.

Optionally, after the positioning step 214, the mounting tool 234 can be leveled using a level 252 in the mounting tool 234 at step 216.

After positioning or leveling the mounting tool 234, the method 200, at step 218 of FIG. 16, can include passing at least one fastener 254 through the at least one fastener-receiving opening in the body of the mounting tool 234 Optionally, the method can include, at step 220, holding the at least one fastener with the mounting tool 234. The fastener-receiving openings are adapted to hold the fastener for insertion. Comparably, a user holding the fastener can injure themselves, or improperly insert the nail. Using the mounting tool 234 to hold the fastener insures a proper insertion of the fastener every time, while providing for hands-free insertion.

Additionally, at step 222, the method 200 can include angling the at least one fastener with the mounting tool 234. The fastener-receiving openings are disposed at an angle, such as thirty degrees in one example, to insert the fastener at the proper angle. Thus, not only is proper insertion achieved, but the optimal insertion angle is achieved providing for secure mounting to the artwork.

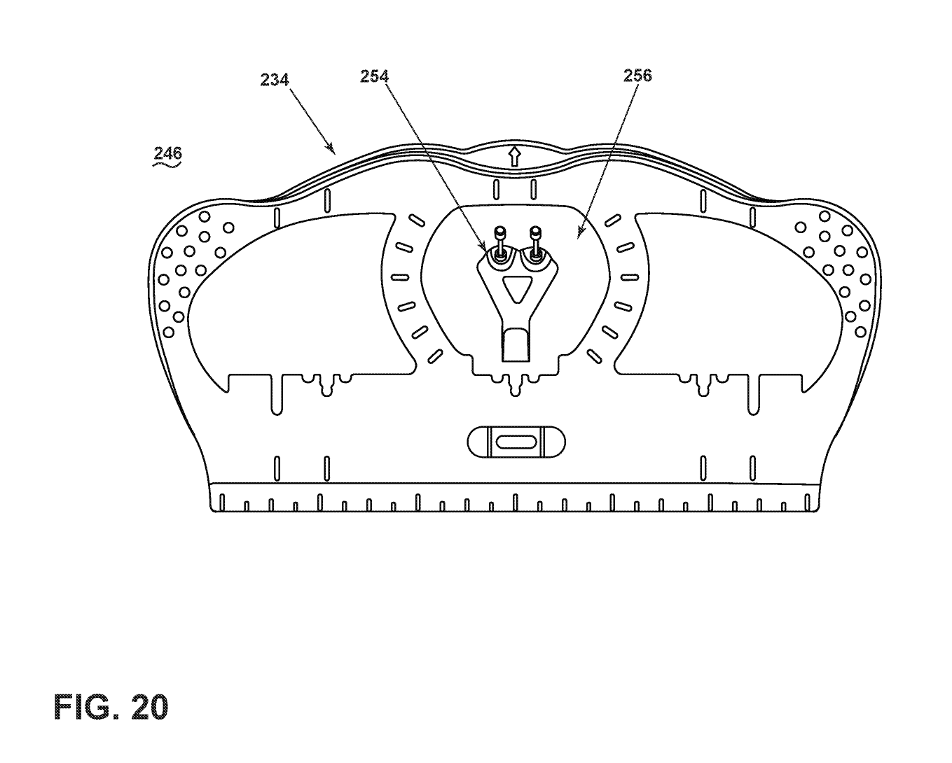

Additionally, at 224, after the passing step 218, the fastener 254 can be secured to the wall 246 through the fastener-receiving opening by gently tapping, such as with a mallet or hammer in non-limiting examples, until the fastener 254 is secured to the wall 246. The mounting tool 234 can be slid downwardly, best seen in FIG. 20, centering the mounting tool 234 within an opening 256 in the body. At step 224, the fastener 254 is only partially inserted into the wall 246. By centering the fastener 254 within the opening 256, the user 230 can fully strike and pound the fastener 254 to fully insert the fastener 254 into the wall 246 without worry of damaging the wall 246.

Finally, the artwork 238 can be hung from the fastener 254, at the exact location that was anticipated in FIG. 18 as the desired position of the artwork 238.

It should be appreciated that the mounting tool as described herein facilitates the measuring, positioning, and mounting of artwork. The mounting tool provides for particularly positioning and mounting artwork. In particular, the mounting tool facilitates the mounting of wire-hung artwork. The mounting tool mimics the tensioned position of the artwork using a hanging wire to accurately anticipate the hanging location. Additionally, the thickness of the tool as well as the height between the straightedge of the tool and the fastener-receiving openings to particularly measure and position inserted fasteners for hanging the artwork at the desired position. The position of the fastener-receiving openings holds the fasteners in place, preventing sliding or movement during insertion of a fastener into the wall. The particular design of the fastener-receiving openings is angled to insert the fasteners into the wall at the manufacturer provided angles, providing for secure mounting.

Additionally, it should be appreciated that the mounting tool facilitates level mounting of artwork, as well as protecting a mounting surface such as a wall during attachment of a fastener, such as pounding of a nail with a hammer. Furthermore, by using a ruler or level, the mounting tool facilitates level and aligned mounting of multiple pieces of artwork along the wall. By using the measured offset instances, multiple pieces of artwork can be hung being perfectly aligned without attempting to anticipate where a wire-hung piece of artwork will ultimately be positioned.

Additionally, it should be understood that the mounting tool is useful in hanging additional wire-hung artwork, as well as any artwork requiring hanging by clips, sawtooths, or metal eyelets.

Furthermore, it should be appreciated that the mounting tool facilitates mounting of artwork, providing for increased accuracy and speed for mounting articles. In an industrial or commercial setting, a user can quickly and accurately mount multiple pieces of artwork using the mounting tool.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A tool for mounting an artwork to a wall, the tool comprising:
a body having a straightedge on a lower portion thereof and an arcuate edge on an upper portion thereof;
a plurality of openings defined in the body between the upper portion and the lower portion, each of the openings having a lower edge generally aligned with the lower portion of the body; and
at least one fastener-receiving opening located in each of the plurality of openings, the at least one fastener-receiving opening configured to receive a plurality of types of fasteners.

2. The tool of claim 1 further comprising a level disposed in the body.

3. The tool of claim 2 wherein the level is located generally parallel with the straightedge.

4. The tool of claim 1 wherein the at least one fastener-receiving opening includes a first opening configured to receive a single-shafted fastener, a pair of second openings in spaced lateral relationship to the first opening, the second openings configured to receive a double-shafted fastener, and a third opening located on one lateral side of the second opening configured to receive at least one of a single-shafted fastener or a double-shafted fastener.

5. The tool of claim 4 wherein the first opening comprises a wide-necked portion extending a distance toward the straightedge that terminates in a narrow-necked portion that extends an additional distance toward the straightedge, whereby the wide-necked portion and narrow-necked portion are configured to receive fasteners of differing diameters.

6. The tool of claim 1 wherein the plurality of types of fasteners includes one or more of nails, screws, clips, locks, anchors, hooks, tacks, bolts, pins, rivets, 20 lb hooks, 30 lb hooks, 50 lb hooks, single-nail hooks, double-nail hooks, single-shafted fasteners, double-shafted fasteners, or triple-shafted fasteners.

7. The tool of claim 1 further comprising hand grip portions located on opposed side portions of the body adjacent to the upper portion thereof.

8. The tool of claim 1 wherein the plurality of openings comprises two openings.

9. The tool of claim 1 wherein the plurality of openings comprises three openings, each separated by an arcuate arm having a bowed portion curving away from a horizontal center of the body.

10. The tool of claim 1 wherein the arcuate edge on the upper portion of the body includes a recess at a central portion thereof.

11. The tool of claim 10 wherein the arcuate edge is shaped similar to an arcuate wire on a piece of artwork.

12. The tool of claim 1 wherein the straightedge is a ruler.

13. The tool of claim 1 further comprising alignment markers disposed on the body and aligned with the at least some of the fastener-receiving openings.

14. The tool of claim 1 wherein the body includes a front and a rear, having a grid area defined in the rear.

15. The tool of claim 14 further comprising an adhesive removably attached to the grid area.

16. The tool of claim 1 wherein the body is made of a robust material designed to receive a pounding force.

17. The tool of claim 1 wherein the lower edge, the straightedge, and the fastener-receiving openings are disposed at an angle adapted to properly orient a fastener.

18. The tool of claim 17 wherein the fastener-receiving openings are adapted to hold the fastener during insertion of the fastener into the wall.

19. A method of mounting a piece of artwork having a hanging wire mounted to a rear surface thereof, onto a wall with a mounting tool including a body having an arcuate upper portion thereof, at least one opening, and at least one fastener-receiving opening defined in the body, the method comprising:
placing the arcuate upper portion of the mounting tool along the hanging wire of the artwork;
tensioning the hanging wire by pushing the arcuate upper portion of the mounting tool toward an upper edge of the artwork;
measuring an offset distance between the upper edge of the artwork and the upper edge of the mounting tool after the tensioning step;
removing the mounting tool from placement with the hanging wire of the artwork;
positioning the mounting tool on the wall at the offset distance lower than a desired upper location of the artwork; and
passing at least one fastener through the at least one fastener-receiving opening in the body of the mounting tool.

20. The method of claim 19 further comprising securing the fastener to the wall through fastener-receiving opening.

21. The method of claim 19 wherein the passing step further includes holding the at least one fastener with the mounting tool.

22. The method of claim 20 wherein the passing step further includes angling the at least one fastener at a manufacturer proscribed angle with the mounting tool.

23. The method of claim 19 further comprising positioning the artwork at a desired position along the wall and positioning the mounting tool or marking the wall along the upper location of the artwork prior to the positioning step.

24. The method of claim 23 further comprising placing an adhesive on a grid area of the mounting tool prior to positioning the mounting tool along the upper location of the artwork.

25. The method of claim 19 further comprising leveling the mounting tool after the positioning step.
